(19) United States
(12) Patent Application Publication
(10) Pub. No.: US 2018/0155559 A1
(43) Pub. Date: Jun. 7, 2018

(54) Powder composition and method for producing three-dimensional objects by selective laser sintering and/or melting.

(71) Applicant: Sinterit Spolka Z Organiczona Odpowiedzialnoscia, Krakow (PL)

(72) Inventors: Pawel Szczurek, Krakow (PL); Konrad Glowacki, Ustka (PL)

(21) Appl. No.: 15/737,682

(22) PCT Filed: Jun. 17, 2016
(86) PCT No.: PCT/IB2016/053632

§ 371 Date: Dec. 18, 2017

(30) Foreign Application Priority Data
Jun. 17, 2015 (PL) PL412719

(51) Int. Cl. C09D 11/101; C09D 11/102; C09D 11/03; B29C 64/153; B29C 64/268; B33Y 10/00; B33Y 70/00

(52) U.S. Cl. CPC C09D 11/101; C09D 11/102; C09D 11/03; C08K 5/42; B29C 64/268; B33Y 10/00; B33Y 70/00; B29C 64/153

(57) ABSTRACT

The invention relates to a composition of powder for producing 3D spatial objects in devices using the process of selective sintering or/and melting using a source of electromagnetic energy, in particular a laser, containing not less than 40% w/w of the basic substance and optionally additional components, in particular selected from the group consisting of a brightener, a visible dye, a pulverised metal or mineral, a carbon or glass fibre, glass beads or UV absorbers, antioxidants, additives for improving the non-flammable properties, additives for improving the liquidity of plastic, characterised in that it contains an absorbing substance, wherein the value of maximum absorbance of the absorbing substance for the waves in the range of 700-6000 nm is not less than 0.05, and the mean absorbance value in the wavelength range of 400-700 nm is at least twice as low as the maximum absorbance for the waves in the range of 700-6000 nm, and the temperature of decomposition and/or melting of the absorbing substance is greater than the melting point of the base powder.

### FIELD OF THE INVENTION

The invention relates to a new composition for producing three-dimensional objects in the process of selective sintering/melting. The invention also relates to a method for producing three-dimensional objects using this process.

The solution according to the invention belongs to the field associated with printing of three-dimensional objects, and more particularly it belongs to the field of techniques of forming plastics, and in particular it relates to forming by heating. The solution that is the object of the invention also relates to chemistry, especially to the use of inorganic and organic substances other than macromolecular ones as components of the mixture.

### STATE OF THE ART

Compositions are known from the prior art that are used for 3D spatial printing in printers using the process of selective sintering and/or melting equipped with a gas laser based on carbon dioxide, in which the active medium is a mixture of carbon dioxide, nitrogen, hydrogen and helium. The laser based on carbon dioxide emits a wave in the infrared range, and the main spectral lines are in the wavelength range of 9400-10600 nm.

Currently the use of diode lasers for 3D spatial printing is being considered, preferably diode lasers emitting waves in the near infrared, instead of large and expensive lasers based on carbon dioxide. Unfortunately waves in this range (700 nm-6000 nm) are not well absorbed by white and colourless plastics, and although their temperature indeed increases due to the laser beam there is a problem with melting them. The solution to this problem in this scope is to change the colour of the base material, e.g. to black colour, which is characterised by a good profile of wave absorption in the near infrared range. As a result, prototype devices currently printing 3D printed objects based on the laser diode technique have the palette of materials that can be used for printing limited to dark colours, and most preferably black colour.

When employing diode lasers currently available in the state of the art for 3D spatial printing the use of light colour powder compositions is not very effective and the printing process is many times longer than in the case of using a laser based on carbon dioxide with the same power, or often it is impossible to obtain a printout.

The U.S. patent application no. U.S. Pat. No. 5,733,497 discloses a powder composition especially adapted for use in selective laser sintering. The powder contains a composite in the form of a dry reinforcing powder, which is mixed with a polymer, also in the form of powder, in which the polymer in the form of powder has a melting point significantly lower than the reinforcing powder. The method for producing a three-dimensional object disclosed in the U.S. patent application comprises the following steps: (i) applying a composite layer of powder on a target surface, wherein the said composite powder contains: from approx. 50% to approx. 90% w/w of a polymer having a melting point and a maximum recrystallization of the polymer; (ii) from approx. 10% to approx. 50% w/w of a reinforcing powder is dry mixed with the pulverised polymer and having a melting point significantly higher than the melting temperature of the polymer powder; and (iii) change of the target surface at a specific temperature—during this application step enabling the successful production of the same; (iv) directing energy at selected locations of the mentioned layer corresponding to the cross-section of the object to be formed in the mentioned layer in order to melt the composite powder; (v) repeating the mentioned steps in order to form a three-dimensional object; (vi) removing loose powder from the mentioned object.

In turn, the international patent application no. WO9630195 discloses a composition of a composite dry powder for 3D spatial printing comprising: i) a polymer powder having a melting peak and crystallization peak which do not overlap, and (ii) a reinforcing powder. The reinforcing powder is dry mixed with the pulverised polymer having a melting point significantly higher than the melting point of the polymer powder.

In order to overcome the limitations present in the prior art, a new composition has been developed for 3D spatial printing that is the object of the invention which, on the one hand, is characterised by a lack of wave absorption in the range visible (or minimal absorption) for a human, and on the other hand, it is possible to use the composition in devices for 3D spatial printing equipped with a diode laser which is the source of waves with a wavelength greater than 700 nm.

### DETAILED DESCRIPTION OF THE INVENTION

The essence of the invention is a composition of powder for producing three-dimensional objects in the process of selective sintering or/and melting using a source of electromagnetic energy, in particular a laser, containing not less than 40% w/w of the basic substance and optionally additional components, in particular selected from the group consisting of a brightener, a visible dye, a pulverised metal or mineral, a carbon or glass fiber, glass beads or UV absorbers, antioxidants, additives for improving the non-flammable properties, additives for improving the liquidity of plastics, characterised in that it contains an absorbing substance, wherein the value of maximum absorbance of the absorbing substance for the waves in the range of 700-6000 nm is not less than 0.05, and the mean absorbance value in the wavelength range of 400-700 nm is at least twice as low as the maximum absorbance for the waves in the range of 700-6000 nm, and the temperature of decomposition and/or melting of the absorbing substance is greater than the melting point of the base powder.

Preferably, the basic substance is one or more components selected from the group consisting of a thermoplastic polymer, a wax, a polyphenol, a polyethylene glycol and/or another material in the form of a powder with a grain diamater of less than 300 μm covered with a thermoplastic polymer, a wax, a polyphenol and/or polyethylene glycol, wherein the melting point of this material is greater than the one of the base substance that covers it. Especially preferably, the basic substance is a thermoplastic polymer selected from the group: polyamide, polystyrene or polycarbonate, PEEK, PEBA, polypropylene or a mixture of these polymers, and particularly preferably, the base substance is a thermoplastic polymer selected from the group: polyamide 11, polyamide 12, polyamide 6.

Preferably, the mean value of absorbance in the wavelength range of 400-700 nm is at least five times less than the maximum absorbance for the waves in the range of 700-6000 nm.

Especially preferably, the value of the maximum absorbance of the absorbing substance for the waves in the range of 700-2000 nm is not less than 0.05, and the mean absorbance value in the wavelength range of 400-700 nm is at least twice as low as the maximum absorbance for the waves in the range of 700-2000 nm.

Equally preferably, the value of the maximum absorbance of the absorbing substance is in the range of 0.6-2.0.

Preferably, the value of the mean molar mass of the absorbing substance is less than 5 000 g/mol.

Preferably, the absorbing substance is a substance selected from the group:
a) ADS775MI, ADS775MP, ADS775PI, ADS775PP, ADS780HO, ADS798SM, ADS800AT, ADS815EI, ADS830AT, ADS1065A, ADS1075A, ADS780WS, ADS785WS, ADS790WS, ADS795WS, ADS830WS, ADS832WS, ADS845MC, ADS870MC, ADS890MC, ADS920MC (American Dye Source, Inc.),
b) Lumogen® IR 1050, Lumogen® IR 765, Lumogen® IR 788 (BASF),
c) SDA4175, SDA5806, SDB1217, SDA5018, SDB3202, SDA3958, SDA3985, SDA9507 (H. W. Sands corp.).

In a preferred embodiment, the absorbing substance covers the base substance and/or additional components. In an equally preferred embodiment, the absorbing substance is a mixture of the base powder and/or additional components. In yet another embodiment, the absorbing substance is contained in the base powder and/or additional components.

The essence of the invention is also a method for producing three-dimensional objects in the process of selective sintering or/and melting using source of electromagnetic energy, characterised in that a composition is used according to any of the preceding claims, and the source of electromagnetic radiation, in particular a laser, is selected such that it emits electromagnetic waves with wavelength range for which the absorbance of the composition according to any of the preceding claims is greater than 0.05.

The absorbing substance used in the composition that is the object of the invention is selected specifically for the laser used in devices using selective laser sintering, preferably SLS printers. The absorbing substance should be selected so that its absorption coefficient for the wavelength of the laser used is as high as possible, wherein the absorbance cannot be less than 0.05. The higher absorbance coefficient the absorbing substance will have in a given wavelength range, the smaller is the quantity of this substance in the composition according to the invention. Absorbing substances that may be used in the solution according to the invention are readily available in the offer of e.g. BASF, American Dye Source, Inc., or H. W. Sands.

Among the advantages of the solution that is the object of the invention it should be noted that it makes it possible to use for 3D spatial printing colourless compositions in the wavelength range visible to humans and that the current limitations will be overcome, where grey powder is used for 3D spatial printing and a laser with a band in the visible wavelength range, which renders printed objects grey in colour. It is also worth noting that due to higher content of carbon and soot in compositions for printing the strength of the final prints is reduced, whereas in the solution according to the invention this problem does not occur.

The object of the invention has been shown in the embodiments and in the attached drawing which is not, however, a restriction of the scope of the application, in which:

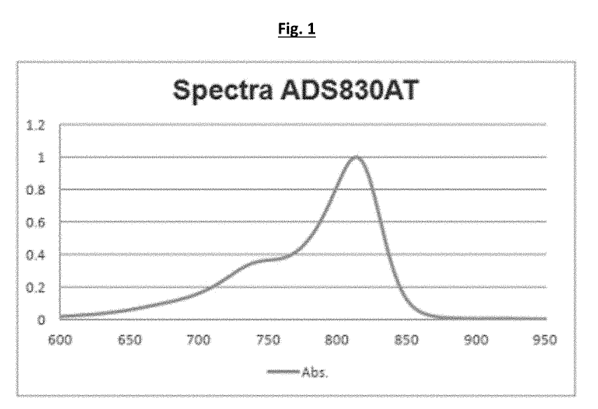

FIG. 1 illustrates the absorbance ADS830AT as a function of the wavelength;

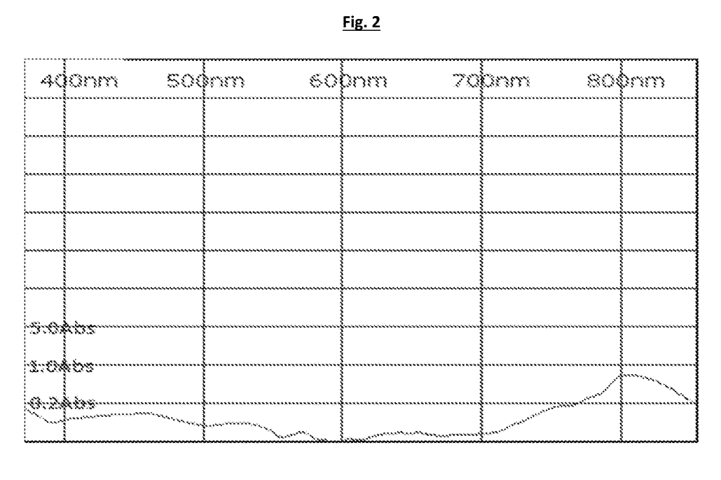

FIG. 2 illustrates the absorbance of the obtained composition with the addition of ADS830AT in relation to the unmodified powder;

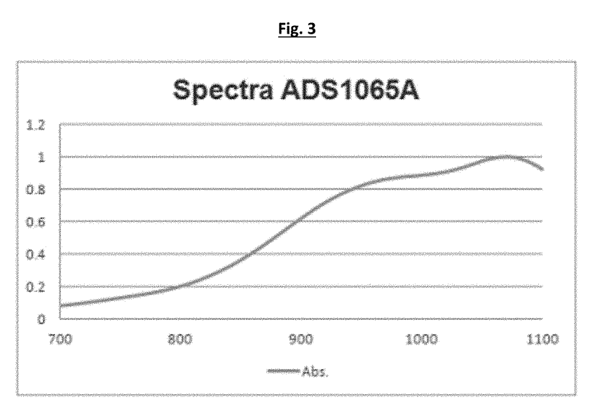

FIG. 3 illustrates the absorbance of the absorbing substance ADS1065A as a function of the wavelength;

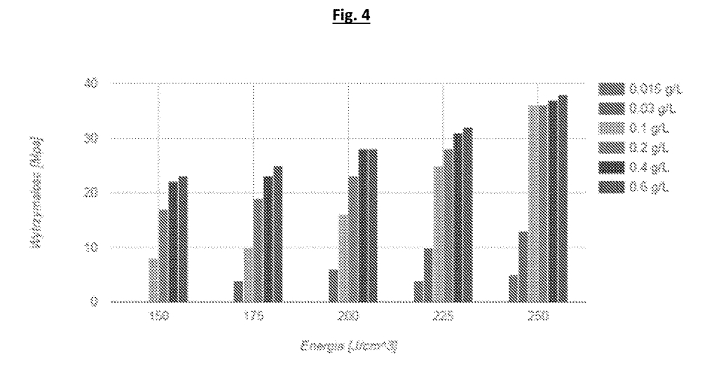

FIG. 4 illustrates the strength in relation to the energy of welding as a function of the amount of the absorbing substance.

### EMBODIMENTS

### EXAMPLE 1

In the first embodiment, the composition was prepared in a multi-step process. In the first step, the absorbing substance ADS830AT (American Dye Source, Inc.) with molar mass of 755.43 g/mole in the form of powder with the Formula I:

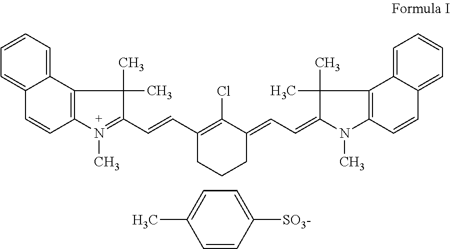

was dissolved in methanol in the following proportions: 0.3 g of dye to 0.7 dm³ of methanol. A graph of the absorption of dye as a function of the wavelength is shown in FIG. 1. The absorbance assumes maximum values for the wavelength in the range of 811-815 nm (laser beam), while the mean absorbance for the range of 400 nm-700 nm (visible light) is at least five times smaller than for the wavelength in the range of 811-815 nm. The absorption of the obtained composition of powder has been illustrated in FIG. 2.

Subsequently, the solution thus obtained was mixed with 450 g of white-coloured nylon powder (PA12, PA2200) (approx. 1 dm³) with an average grain size equal to about 56 μm. In the next step, methanol has been evaporated and after the evaporation the powder was sieved through a sieve with openings of 200 μm in diamater in order to get rid of contaminations and clumps. As a result of the said procedure, a powder was obtained with the following composition:

99.94% w/w PA 12 (PA2200) and

0.06% w/w of the absorbing dye ADS830AT.

Subsequently, the obtained composition was used for making three-dimensional objects in a 3D spatial printer equipped with a laser of 808 nm, for which the absorbance of its rays increases to a level that allows for melting the powder with a laser with a power of 5 W, where the solutions used in the prior art did not allow for using lasers with such low power with this wavelength.

The obtained result may be compared as in the case of using a laser based on carbon dioxide. In this case, however, the energy generated by the laser necessary to melt plastic in a SLS printer is approx. 200 J/cm³. The mechanical properties of the printed products are at a comparable level. Print colour is similar to the colour of the base powder.

### EXAMPLE 2

In the second embodiment ADS830AT was also used as the absorbing substance. It was dissolved in methanol in the proportions: 0.3 g to 0.7 dm³ of methanol. The mean absorbance of the absorbing substance for the range of 400 nm-700 nm (visible light) is at least five times smaller than for the wavelength range of 811-815 nm.

Subsequently, the solution thus obtained was mixed with nylon powder with an addition of pulverised aluminum (PA 12 (PA2200) Al+30%) 1.0 dm³ (670 g) of a grey-coloured powder. In the next step, methanol has been evaporated and after the evaporation the powder was sieved in order to get rid of contaminations and clumps. As a result of the said procedure a powder was obtained with the composition:

69.258% w/w PA 12

29.682% w/w Al

0.04% w/w of the absorbing dye ADS830AT

Subsequently, the obtained composition was used for producing three-dimensional objects in a 3D spatial printer equipped with a 808 nm laser, for which the absorbance increases to a level that allows for melting the powder with a laser with a power of 5 W.

The obtained result may be compared as in the case of using a laser based on carbon dioxide. In this case, however, the energy generated by the laser necessary to melt plastic in a SLS printer is approx. 250 J/cm³. The colour and mechanical properties of the printed products are at a comparable level.

As a result of the printing, mechanical properties have not changed, the obtained product was characterised by a metallic colour.

### EXAMPLE 3

In the third embodiment, the composition has been prepared in a multi-stage process. In the first step absorbing dye ADS1065A (American Dye Source, Inc.) with a molar mass of 1392.92 g/mol in the form of a powder with the Formula II:

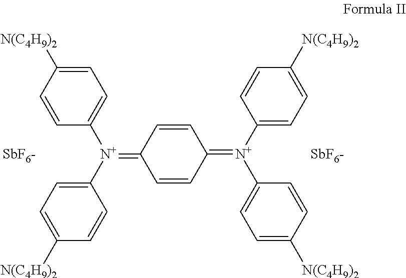

was dissolved in methanol in the proportions: 2.0 g of dye to 0.7 dm³ of methanol. A graph of the dye absorption as a function of wavelength is in FIG. 3, where the absorption assumes maximum values for the wavelength range of 950 nm-1100 nm (laser beam). The mean absorbance of the absorbing substance for the range of 400 nm-700 nm (visible light) is at least five times lower than for the wavelength range of 950 nm-1100 nm.

Subsequently, the solution thus obtained was mixed with nylon powder (PA 11) with the grain size of less than 150 μm, 1 dm³ (450 g) of powder of white colour. In the next step, methanol was evaporated and after the evaporation it was sieved in order to get rid of dirt and grit. As a result of the said procedure a powder was obtained with the following composition:

99.56% w/w PA 11 and

0.44% w/w of the absorbing dye ADS1065A.

Subsequently, the obtained composition was used for producing three-dimensional objects in a 3D spatial printer equipped with a 980 nm laser, for which the absorbance of its rays increases to a level allowing for melting the powder with a 5W laser.

The results obtained in examples 1-3 can be compared to the effects obtained using lasers based on carbon dioxide. In this case, however, the energy generated by the laser necessary to melt plastic in a SLS printer is approx. 220 J/cm³. Mechanical properties of printed products are at a comparable level. Print colour is similar to the base powder.

### EXAMPLE 4.

### Study of the Effect of Dye Content on Strength

Six compositions of powder according to the invention were prepared in accordance with the procedure used in the first embodiment with the following composition:

1. 0.015 g of dye for 450 g PA12 of powder

2. 0.03 g of dye for 450 g PA12 of powder

3. 0.1 g of dye for 450 g PA12 of powder

4. 0.2 g of dye for 450 g PA12 of powder

5. 0.4 g of dye for 450 g PA12 of powder

6. 0.6 g of dye for 450 g PA12 of powder

On the basis of the formula of Lambert-Bel it can be calculated that the absorbance for the samples will be as follows for powders with the composition given above:

1. A₁=300*0.015*0.01=0.05 (approx. 11% of the laser beam will be absorbed in the first layer of powder)

2. A₂=300*0.03*0.01=0.1 (approx. 20% of the laser beam will be absorbed in the first layer of powder)

3. A₃=300*0.1*0.01=0.3 (approx. 50% of the laser beam will be absorbed in the first layer of powder)

4. A₄=300*0.2*0.01=0.6 (approx. 75% of the laser beam will be absorbed in the first layer of powder)

5. A₅=300*0.4*0.01=1.2 (approx. 94% of the laser beam will be absorbed in the first layer of powder)

6. A₆=300*0.6*0.01=1.8 (approx. 98% of the laser beam will be absorbed in the first layer of powder)

This may lead to a conclusion that differences between samples 5 and 6 will be minimal.

For each of the above composition variations 5 samples were printed using a different energy density: 150 J/cm³, 175 J/cm³, 200 J/cm³, 225 J/cm³, 250 J/cm³. Subsequently, each sample was subjected to tearing strength tests, and the results obtained have been presented in the table below and in FIG. 4.

| | dye content [g/L] | | | | | |
|---|---|---|---|---|---|---|
| | 0.015 g/L | 0.03 g/L | 0.1 g/L | 0.2 g/L | 0.4 g/L | 0.6 g/L |
| 150 | 0 | 0 | 8 | 17 | 22 | 23 |
| 175 | 0 | 4 | 10 | 19 | 23 | 25 |
| 200 | 0 | 6 | 16 | 23 | 28 | 28 |
| 225 | 4 | 10 | 25 | 28 | 31 | 32 |
| 250 | 5 | 13 | 36 | 36 | 37 | 38 |
| | blue | red | yellow | green | purple | grey |

From the above data it can be concluded that the increase in the amount of the absorbing substance (dye) at a constant amount of energy fed by the laser contributed to the increase in the strength of the sample. This is due to the fact that energy is better absorbed and used for the melting process, not dispersed. The more energy was used for melting, the better the powder was melted and it bound more strongly forming a printed object.

In the vicinity of 36-38 Mpa the limit value can be observed and this is related to the maximum strength of the material which was used for printing. For small values of energy (150-200 J/cm³) it can be observed that the strength is proportional to the value of theoretical absorbance of the sample. For samples 3 and 4, the strength values are very similar regardless of the amount of the energy used, which corresponds to the theoretical calculations.

1-13. (canceled)

14. A composition for 3D spatial printing by selective laser sintering comprising:
from 99.56% to 99.997% by weight of a selective laser sintering fabrication material; and
the remaining balance by weight being an absorption dye;
wherein said absorption dye has a mean absorption value for electromagnetic waves in the range of 700-6000 nm that is at least twice the mean absorption value for electromagnetic waves in the range of 400-700 nm; and
wherein the melting temperature of the absorption dye is greater than the melting point of the fabrication material.

15. The composition of claim 14, wherein the fabrication material comprises a thermoplastic polymer selected from the group consisting of: polyamide, polystyrene or polycarbonate, PEEK, PEBA, polypropylene, or a mixture of these polymers.

16. The composition of claim 14, wherein the fabrication material comprises a polyamide selected from the group consisting of: polyamide 11, polyamide 12, polyamide 6.

17. The composition of claim 14, wherein said absorption dye has a mean absorption value for electromagnetic waves in the range of 700-6000 nm that is at least five times the mean absorption value for electromagnetic waves in the range of 400-700 nm.

18. The composition of claim 17, wherein the fabrication material comprises a thermoplastic polymer selected from the group consisting of: polyamide, polystyrene or polycarbonate, PEEK, PEBA, polypropylene, or a mixture of these polymers.

19. The composition of claim 17, wherein the fabrication material comprises a polyamide selected from the group consisting of: polyamide 11, polyamide 12, polyamide 6.

20. The composition of claim 14, wherein the composition comprises from 99.940% to 99.960% by weight of the fabrication material.

21. The composition of claim 20, wherein the fabrication material comprises a thermoplastic polymer selected from the group consisting of: polyamide, polystyrene or polycarbonate, PEEK, PEBA, polypropylene, or a mixture of these polymers.

22. The composition of claim 20, wherein the fabrication material comprises a polyamide selected from the group consisting of: polyamide 11, polyamide 12, polyamide 6.

23. A method for producing a 3D spatial print comprising the steps of:
creating a diode laser mixture by mixing a laser sintering fabrication material with an absorption dye;
applying a diode laser to the mixture to meld dimensional layers of the 3D spatial print.

24. The method of claim 23, wherein the diode laser has an energy density of between 150 J/cm³ and 250 J/cm³.

25. The method of claim 23, wherein the diode laser has a functional wavelength range in the infrared spectrum between 700 nm and 6,000 nm.

26. The method of claim 25, wherein the diode laser is operated in a low-watt mode.

27. The method of claim 26, wherein the diode laser is operated at 5 watts.
